(19) United States
(12) Patent Application Publication
(10) Pub. No.: US 2026/0161465 A1
(43) Pub. Date: Jun. 11, 2026

(54) TRANSFORMER COMPUTATION BLOCK, COMPUTATION ACCELERATOR NODE AND METHOD FOR DRIVING COMPUTATION ACCELERATOR NODE

(71) Applicant: Electronics and Telecommunications Research Institute, Daejeon (KR)

(72) Inventors: Jin Kyu KIM, Daejeon (KR); Ju Yeob KIM, Daejeon (KR); Jin Ho HAN, Daejeon (KR)

(73) Assignee: Electronics and Telecommunications Research Institute, Daejeon (KR)

(21) Appl. No.: 19/409,892

(22) Filed: Dec. 5, 2025

(30) Foreign Application Priority Data
Dec. 6, 2024 (KR) 10-2024-0180492
Apr. 9, 2025 (KR) 10-2025-0045933

(51) Int. Cl. G06F 9/50; G06N 3/0455

(52) U.S. Cl. CPC G06F 9/5027; G06N 3/0455

(57) ABSTRACT

A transformer computation block with a plurality of acceleration nodes connected thereto is provided. Each acceleration node includes: a first transceiver through which data is input and output; a second transceiver through which data is input and output; a PCI interface; an interconnect switch for routing data within the computation accelerator; a high bandwidth memory; and a computation core including a computation unit performing MAC operations, an internal memory, and a control unit for performing computations. The computation block is configured to function as one of an encoder block and a decoder block of a transformer according to provided data.

### CROSS-REFERENCE TO RELATED APPLICATIONS

This application claims priorities to Korean Patent Applications No. 10-2024-0180492, filed on Dec. 6, 2024 and No. 10-2025-0045933, filed on Apr. 9, 2025, the entire contents of which are hereby incorporated by reference.

### BACKGROUND

The present disclosure generally relates to a transformer computation block, a computation accelerator node, and a method for driving a computation accelerator node.

Recently, transformer-based artificial neural network services, including OpenAI's ChatGPT and Meta's Llama ⅔, have become widely distributed and expanded. Such artificial neural networks require substantial matrix-based numerical computation capabilities, and thus, accelerators utilizing GPUs, such as those from Nvidia, are essentially required.

GPU hardware requires high hardware power consumption, making it difficult to use in mobile or edge-based AI services.

The present disclosure aims to provide an acceleration device having a computation flow suitable for artificial intelligence computation and capable of being used with high efficiency in computation devices according to data transfer.

### SUMMARY

According to one aspect of the present disclosure, a transformer computation block with a plurality of acceleration nodes connected thereto is provided, wherein each of the acceleration nodes includes: a first transceiver through which data is input and output; a second transceiver through which data is input and output; a Peripheral Component Interconnect (PCI) interface; an interconnect switch for routing data within the computation accelerator; a high bandwidth memory; and a computation core including a computation unit performing MAC operations, an internal memory, and a control unit for performing computations, wherein the computation block is configured to function as one of an encoder block and a decoder block of a transformer according to provided data.

According to another aspect of the present disclosure, the computation accelerator node is configured to perform one of operator functions including linearization, concatenation, layer normalization, matrix multiplication, scale, and softmax of a transformer according to input data.

According to another aspect of the present disclosure, in the transformer computation block, a preceding acceleration node provides feature data to a subsequent acceleration node configured to perform the configured operator function.

According to another aspect of the present disclosure, the acceleration node receives training data through one or more of the first transceiver, the second transceiver, and the PCI interface, wherein the training data includes one or more of: a number of self-attention heads; a number of model layers being the number of layers of each of the encoder and decoder; a model dimension being an output dimension of the layer; and an internal dimension of a multi-layer perceptron.

According to another aspect of the present disclosure, the first transceiver and the second transceiver are gigabit transceivers, and the transformer computation block has each of the plurality of acceleration nodes connected by the gigabit transceivers.

According to another aspect of the present disclosure, in the transformer computation block, a preceding acceleration node transmits function parameters to a subsequent acceleration node to configure the function of the transformer computation block.

According to another aspect of the present disclosure, in the transformer computation block, a preceding acceleration node transmits operator parameters to a subsequent acceleration node to configure an operator to be performed by the subsequent acceleration node.

According to another aspect of the present disclosure, the operator is one of linearization, concatenation, layer normalization, matrix multiplication, scale, softmax, addition, and activation function operators.

According to another aspect of the present disclosure, the preceding acceleration node transmits flow control parameters to a subsequent acceleration node to control the computation flow of the layer normalization operator.

According to another aspect of the present disclosure, in the transformer computation block, a preceding acceleration node transmits size configuration parameters for configuring the size of matrices or vectors used in internal blocks of a subsequent acceleration node.

According to another aspect of the present disclosure, in the transformer computation block, a first preceding acceleration node is configured by being provided with the data through the PCI interface.

According to another aspect of the present disclosure, in the transformer computation block, a last subsequent acceleration node outputs computation data through the PCI interface.

According to another aspect of the present disclosure, in the transformer computation block, the two or more acceleration nodes operate in a pipeline manner.

According to another aspect of the present disclosure, a computation accelerator node is provided, wherein the computation accelerator node includes: a first transceiver and a second transceiver through which data is input and output; a PCI interface; a PCI controller for controlling the PCI interface; an interconnect switch for routing data within the computation accelerator; a high bandwidth memory; and a computation core including a MAC array performing MAC operations, an internal memory, and a control unit for performing computations, wherein the computation accelerator node performs an operator function of a transformer according to input data.

According to another aspect of the present disclosure, the operator is one of linearization, concatenation, layer normalization, matrix multiplication, scale, and softmax operators.

According to another aspect of the present disclosure, the first transceiver and the second transceiver are gigabit transceivers that input and output serial stream data.

According to another aspect of the present disclosure, a method for driving a plurality of computation accelerator nodes as a transformer computation block is provided, wherein the method includes: configuring the computation accelerator node to correspond to training data upon the computation accelerator node receiving the training data; configuring the computation accelerator node to correspond to node configuration data upon receiving node configuration data from a preceding computation accelerator node; receiving feature data from the preceding computation accelerator node; and outputting a computation result by performing computation with the provided feature data by the computation accelerator node configured with the training data and the node configuration data.

According to another aspect of the present disclosure, the plurality of computation accelerator nodes are driven in a pipeline manner.

According to another aspect of the present disclosure, the configuring of the computation accelerator node to correspond to the node configuration data is performed by configuring the computation accelerator node according to the node configuration data for performing one of operator functions including linearization, concatenation, layer normalization, matrix multiplication, scale, and softmax.

According to another aspect of the present disclosure, the configuring of the computation accelerator node to correspond to the node configuration data is performed by configuring the computation accelerator node to function as one of a transformer encoder block and a decoder block.

According to the present disclosure, there is provided an advantage of implementing an accelerator that characteristically performs hardware acceleration for encoder blocks or decoder blocks used in transformer models in artificial intelligence neural networks and performs high-speed inference, and an advantage of being efficient in processing prompts input sequentially.

### BRIEF DESCRIPTION OF DRAWINGS

FIG. 1A is a block diagram illustrating an overview of a transformer encoder unit block, FIG. 1B is a block diagram illustrating an overview of a multi-head self-attention block, and FIG. 1C is a diagram illustrating an overview of a scaled dot-product attention block.

FIG. 2 is a diagram illustrating an overview of a multi-layer perceptron block among transformer encoder blocks.

FIG. 3 is a diagram illustrating an overview of a computation accelerator node according to the present embodiment.

FIG. 4 is a diagram illustrating a MAC operator according to the present embodiment.

FIG. 5 is a flowchart illustrating an operation method of the computation accelerator node according to the present embodiment.

FIGS. 6 to 9 are diagrams illustrating a plurality of interconnected computation accelerator nodes performing the function of a scaled dot-product attention block.

### DETAILED DESCRIPTION

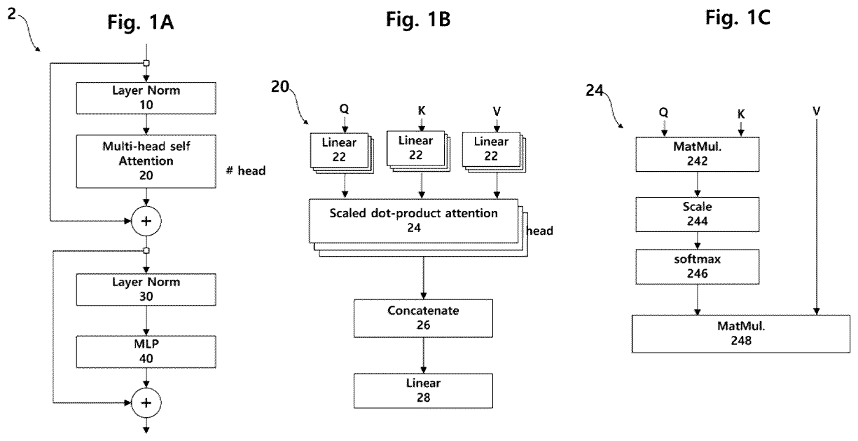

Hereinafter, the example embodiments will be described with reference to the accompanying drawings. FIG. 1A is a block diagram illustrating an overview of a transformer encoder unit block 2, FIG. 1B is a block diagram illustrating an overview of a multi-head self-attention block 20, and FIG. 1C is a diagram illustrating an overview of a scaled dot-product attention block 24.

As will be described later, the computation accelerator node of the present embodiment may be configured and function as an encoder or decoder of a transformer by providing parameters.

Referring to FIG. 1A, the unit block 2 of the transformer encoder includes a layer normalization block (Layer norm) 10, a multi-head self-attention block 20, a layer normalization block 30, and a multi-layer perceptron block 40.

The layer normalization blocks 10 and 30 adjust the mean and standard deviation of input data so that the input of each layer has a stable distribution, thereby improving the learning speed and stability of the model. In one embodiment, the operation of the layer normalization blocks 10 and 30 may be expressed as in the following equation.

$$[ Equation 1 ]$$

$$μ = \frac{1}{d} {\sum }_{i = 1}^{d} {x}_{i} \qquad ( 1 )$$

$$σ = \sqrt{\frac{1}{d} {\sum }_{i = 1}^{d} {( {x}_{i} - μ )}^{2}} \qquad ( 2 )$$

$$\hat{x} = \frac{x - μ}{σ} \qquad ( 3 )$$

$$LayerNorm ( x ) = γ \frac{( x - μ )}{σ} + β \qquad ( 4 )$$

(μ: mean of input vector elements, σ: standard deviation of input elements, d: dimension of input vector, \hat{x}: normalized input vector, γ: gain, β: offset)

Layer normalization 10 and 30 is applied to vectors, where the input of the layer normalization blocks 10 and 30 is a single vector of dimension d, and the output is a normalized vector of dimension d. In layer normalization, the mean μ and standard deviation σ for each element of the vector to be normalized are calculated as in equations \textcircled{1} and \textcircled{2} of Equation 1. Vector components are normalized from the mean μ and standard deviation σ values as in equation \textcircled{3}. The result of equation \textcircled{3} operation is a normalized vector with mean 0 and standard deviation 1. As expressed in equation \textcircled{4}, layer normalization output is formed by introducing two learnable parameters γ and β representing gain and offset values.

The layer normalization performed by the layer normalization block 10 improves the expressiveness of the multi-head self-attention block 20, thereby allowing the multi-head self-attention block 20 to effectively capture various aspects of input data. In the illustrated embodiment, the layer normalization block 10 is positioned before the multi-head self-attention block 20 and/or the multi-layer perceptron block 40. This increases the stability of initial gradients and improves learning speed. However, in other embodiments not shown, the layer normalization block may be positioned after the multi-head self-attention block and/or the multi-layer perceptron block, and such configuration maintains better performance in shallow transformer models.

FIG. 1B is a diagram illustrating an overview of the multi-head self-attention block 20, and FIG. 1C is a block diagram schematically illustrating the scaled dot-product attention block 24 of FIG. 1B. Referring to FIGS. 1B and 1C, the multi-head self-attention block 20 includes a plurality of heads, and each head includes linearization blocks 22 converting Q matrix, K matrix, and V matrix into vectors, an attention block (Scaled dot-product attention) 24, a concatenation block 26, and a linearization block 28.

The input to the transformer is converted into a Q vector (Query, Q), K vector (Key, K), and value vector (Value, V) through linearization blocks 22. The linearization blocks 22 adjust the dimensions of input data to convert it into a form suitable for subsequent self-attention operations.

In the matrix multiplication operation block 242 of the scaled dot-product attention block 24, the dot product between the Q vector and the K vector is computed, and this process is as in the following equation.

$$\dot{dot product} = Q \cdot {K}^{T} \qquad [ Equation 2 ]$$

That is, in the matrix multiplication operation block 242, the dot product is computed by computing the matrix multiplication of the Q vector and the transposed K vector.

The scale block 244 obtains an attention score by scaling the dot product computed in the matrix multiplication operation block 242 according to the dimension of the K vector, and this process is as in the following equation.

$$score = \frac{\dot{dot product}}{\sqrt{{d}_{k}}} = \frac{Q \cdot {K}^{T}}{\sqrt{{d}_{k}}} \qquad [ Equation 3 ]$$

(dk: dimension of K vector)

By scaling by the dimension of the K vector, excessive increase of attention scores is prevented.

As in the following equation, the softmax function operation unit 246 applies a softmax function to the computed attention score to obtain weight w.

$$w = softmax ( \frac{Q \cdot {K}^{T}}{\sqrt{{d}_{k}}} ) \qquad [ Equation 4 ]$$

The softmax function operation block 246 causes the weight w value to have a range between 0 and 1.

The matrix multiplication operation block 248 computes and outputs a weighted sum of the formed weight w and the V vector. This process is as in the following equation.

$$weighted = w \cdot V \qquad [ Equation 5 ]$$

As illustrated, the multi-head self-attention block 20 may include multiple attention heads. The concatenation block 26 combines the outputs of each attention head, thereby capturing different aspects of input data and combining these outputs to allow the model to effectively utilize various relationships. The concatenation block 26 concatenates the output of each attention head to combine them into a single matrix for output, and adjusts the dimension of the combined output to match the original input dimension.

The linearization block 28 connects the outputs of multiple heads after the operation of the concatenation block 26 and finally transforms them through one linearization block 28 to generate the final output.

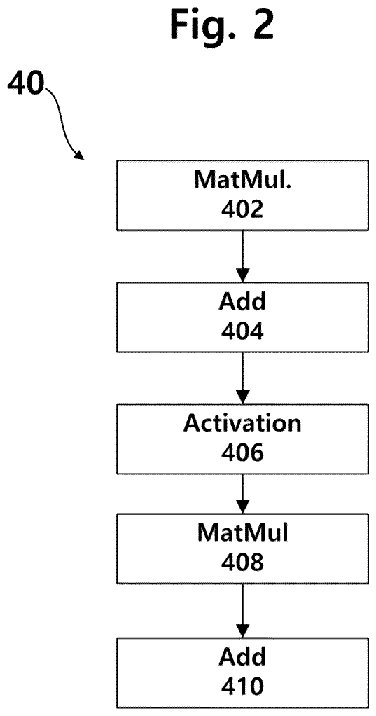

FIG. 2 is a diagram illustrating an overview of the multi-layer perceptron block 40 among transformer encoder blocks. Referring to FIG. 2, the multi-layer perceptron block 40 has a structure that independently transforms the representation of each token and is a type of feedforward neural network (FNN). This enriches the information obtained through attention.

In one embodiment, the multi-layer perceptron block 40 includes a linear layer including a matrix multiplication operation block 402 and an addition block 404, an activation function block 406 positioned between two linear layers including a matrix multiplication operation block 408 and an addition block 410. In one embodiment, the multi-layer perceptron block 40 performs computation as in the following equation, and one of a RELU (Rectified Linear Unit) function and a GELU (Gaussian Error Linear Unit) function is applied in the activation function block 406.

$$MLP ( {x}_{i} ) = Activation ( {W}_{1} {x}_{i} + {b}_{1} ) {W}_{2} + {b}_{2} \qquad [ Equation 6 ]$$

(Activation: activation function, xi: input, W1, W2: weight matrices, b1, b2: bias vectors)

The linear layer including the matrix multiplication operation block 402 and the addition block 404 increases the input dimension by n times to allow the model to learn more complex relationships, thereby improving the model's expressiveness, and the linear layer including the matrix multiplication operation block 408 and the addition block 410 restores the original dimension.

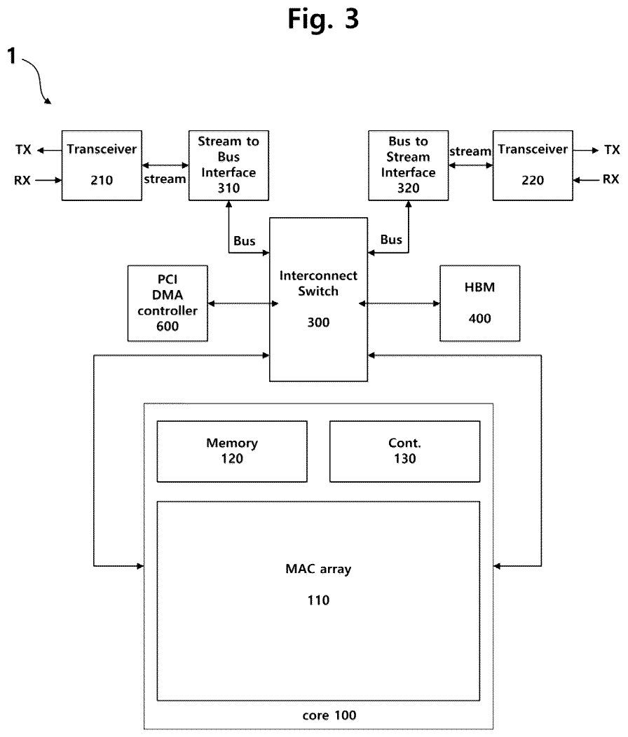

FIG. 3 is a diagram illustrating an overview of the computation accelerator node 1 of the present embodiment. Referring to FIG. 3, the computation accelerator node 1 includes a first transceiver 210 and a second transceiver 220 through which data is input and output, an interconnect switch 300 for routing data within the computation accelerator node 1, a high bandwidth memory 400, and a core 100 including a MAC array 110 performing MAC operations, an internal memory 120, and a control unit 130. In the example of the illustrated computation accelerator node 1, a second transceiver 220 included in one acceleration node 1 and a transceiver 210 included in another acceleration node 1 are connected to perform node-to-node communication to perform transformer block operations. The first transceiver 210 and the second transceiver may each include any one or any combination of a digital modem, a radio frequency (RF) modem, an antenna circuit, a WiFi chip, and related software and/or firmware.

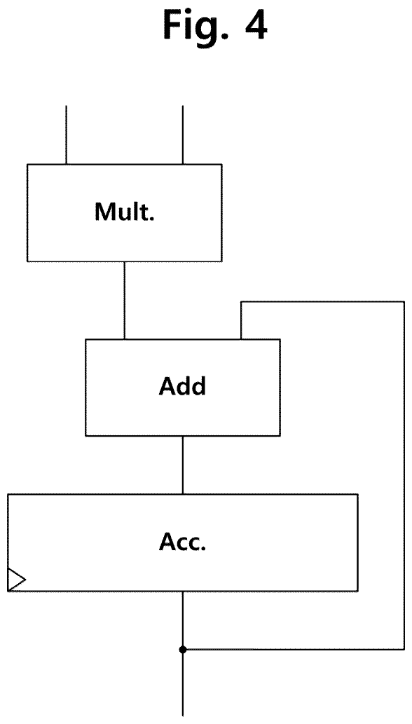

The computation core 100 includes a MAC array 110 in which a plurality of MAC (multiply and accumulate) operators arranged in an array for performing MAC operations. In one embodiment, as illustrated in FIG. 4, the MAC operator includes a multiplier (Mult.) that multiplies two inputs and outputs, and an adder (Add) that receives and sums the output of the multiplier (Mult.) and the output of an accumulation register (Acc).

The computation core 100 includes a control unit 130. In one embodiment, the control unit 130 may store data received by the first transceiver 210 or the second transceiver 220 in the high bandwidth memory 400 through the interconnect switch 300, or fetch data stored in the high bandwidth memory 400 and store it in the internal memory 120. Also, the control unit 130 may store results computed by the computation core 100 in the internal memory 120 or in the high bandwidth memory 400. In one embodiment, the control unit 130 may be a RISC-V core. In one embodiment, the high bandwidth memory 400 may be HBM3 or HBM4 high bandwidth memory. Also, the internal memory 120 may be one of cache memory and scratch memory and may be SRAM.

The first transceiver 210 and the second transceiver 220 are, in one embodiment, gigabit high bandwidth transceivers having Gbit bandwidth. The first transceiver 210 receives receive data (RX) and outputs it as a serial stream, and outputs data provided as a serial stream as transmit data (TX). This enables high-speed data transmission required for transformer computation.

Data streams (RX) received by the first transceiver 210 and the second transceiver 220 are provided to bus interfaces 310 and 320, converted to parallel buses, and provided to the interconnect switch 300. Also, data provided to the bus interfaces 310 and 320 via parallel buses is converted by the bus interfaces 310 and 320 to serial streams and provided to the first transceiver 210 and the second transceiver 220, and the first transceiver 210 and the second transceiver 220 transmit the provided data as transmit data (TX). In one embodiment, the computation accelerator node 1 includes a PCI (Peripheral Component Interconnect) interface and a PCI controller 600. In one embodiment, the PCI controller 600 may provide data provided through the PCI interface to the high bandwidth memory 400.

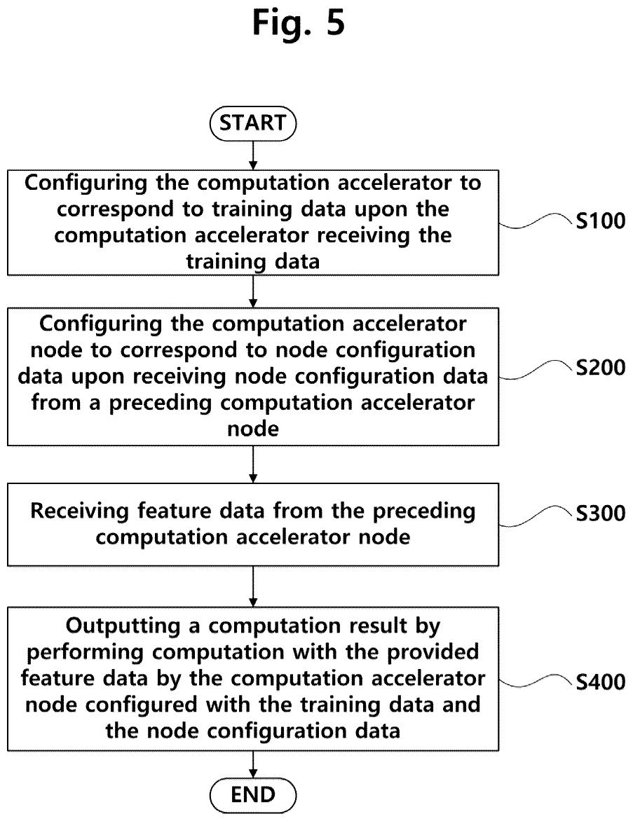

FIG. 5 is a flowchart illustrating an operation method of the computation accelerator node 1 of the present embodiment. Referring to FIG. 5, a method for driving a plurality of computation accelerator nodes as a transformer computation block includes: configuring the computation accelerator to correspond to training data upon the computation accelerator receiving the training data (S100); configuring the computation accelerator node to correspond to node configuration data upon receiving node configuration data from a preceding computation accelerator node (S200); receiving feature data from the preceding computation accelerator node (S300); and outputting a computation result by performing computation with the provided feature data by the computation accelerator node configured with the training data and the node configuration data (S400).

The computation accelerator node 1 is configured according to provided training data (S100). In one embodiment, training data may be provided to the computation accelerator node 1 through the PCI interface. The PCI controller 600 stores training data provided through the PCI interface in the high bandwidth memory 400. In another embodiment, training data may be provided by a preceding computation accelerator node through node-to-node communication. The control unit 130 stores the provided training parameters in the high bandwidth memory 400.

The provided training parameters may be the number of self-attention heads, the number of model layers being the number of layers of each of the encoder and decoder, the model dimension being the output dimension of each layer, and the internal dimension of the multi-layer perceptron.

The computation accelerator node 1 is configured to correspond to provided node configuration data (S200). In one embodiment, node configuration data may be transmitted from a preceding computation accelerator node through node-to-node communication. In another embodiment, among the plurality of computation accelerator nodes, the first preceding acceleration node may be provided with node configuration data through the PCI interface by an external device.

The node configuration data may be one or more of function parameters, operator parameters, size configuration parameters, activation function setting parameters, and flow control parameters of the computation accelerator node 1. The function parameters are parameters for configuring whether the computation accelerator node 1 will function as a transformer encoder block or a decoder block.

The operator parameters are parameters regarding the operator to be performed by the computation accelerator node 1. As an example, they are parameters for the operator to be performed by the computation accelerator node 1 among operators illustrated in FIGS. 1 and 2, such as matrix multiplication 242, 248, 402, and 408, scale 244, and softmax 246. The size configuration parameters are parameters for configuring the size of matrices or vectors used in internal blocks of the computation accelerator node 1 performing operators, the activation function setting parameters are parameters for configuring the activation function used in the multi-layer perceptron block 40, and the flow control parameters are parameters for computation flow control in the layer normalization blocks 10 and 30.

In one embodiment, the control unit 130 receives node configuration data for configuring whether to function as a transformer encoder block or a decoder block, and provides it to the computation core 100 to configure it to perform the corresponding function. Also, it configures the internal memory 120 and the high bandwidth memory 400 according to the size of matrices or vectors included in the node configuration data, and configures the acceleration node 1 according to data for setting the activation function 406 (see FIG. 2) configured with the configuration data or for flow control of operators such as layer normalization 10 and 30.

In one embodiment, the PCI controller 600 may provide node configuration data provided through the PCI interface to the control unit 130 through the interconnect switch 300 to perform the desired operation. Therefore, according to node configuration data provided from an external device, the control unit 130 may configure the computation accelerator node 1 to function as an encoder block of the transformer or to function as a decoder block of the transformer.

The computation accelerator node 1 receives feature data from a preceding computation accelerator node (S300), and the computation accelerator node 1 configured to correspond to training data and node configuration data performs computation with the provided feature data and outputs a computation result (S400). Feature data refers to matrix or vector data input and/or output at each block, and the computation accelerator node 1 configured to correspond to training data and node configuration data performs computation with the provided feature data. Due to the characteristics of transformer models, the values of matrices and vectors used in encoders or decoders are fixed according to the model and are used identically between blocks, so repeated reuse may be possible.

The plurality of interconnected acceleration nodes 1 are configured to perform operator functions according to provided training parameters and node configuration data, and compute input feature data and output to subsequent acceleration nodes. However, among the plurality of interconnected acceleration nodes, the last acceleration node may output the computed result to an external device (not shown) through the PCI interface.

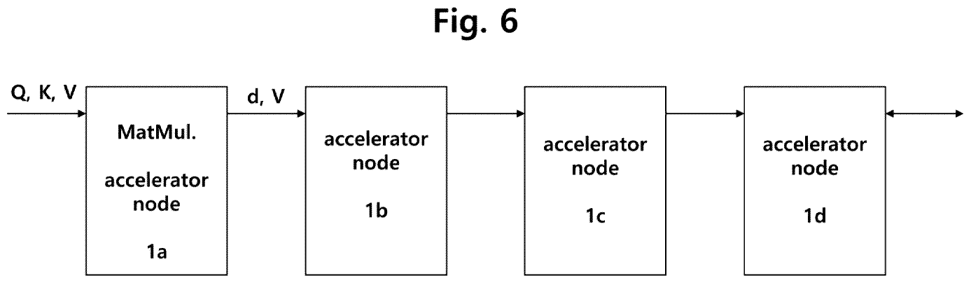

FIGS. 6 to 9 are diagrams illustrating a plurality of interconnected computation accelerator nodes 1a, 1b, 1c, and 1d performing the function of a scaled dot-product attention block. Referring to FIGS. 1 to 6, an external device (not shown) provides training data to the connected computation accelerator nodes 1a, 1b, 1c, and 1d. As described above, the provided training parameters may be the number of self-attention heads, the number of model layers being the number of layers of each of the encoder and decoder, the model dimension being the output dimension of each layer, and the internal dimension of the multi-layer perceptron.

A preceding computation accelerator node (not shown) provides node configuration data for subsequent computation accelerator nodes 1a, 1b, 1c, and 1d. As another example, an external device (not shown) provides node configuration data through the PCI interface of computation accelerator node 1a. As described above, the node configuration data may include function parameters for determining whether each computation accelerator node will function as an encoder or decoder, operator parameters for configuring the operator to be performed, computation parameters for configuring the size of matrices or vectors used in computation, activation function setting parameters for configuring the type of activation function used in the multi-layer perceptron block 40, and data for flow control of the layer normalization operator (see FIG. 3, 30).

In the example illustrated in FIG. 6, the computation accelerator node 1a performs the function of the matrix multiplication 242 operator of the encoder. Q vector, K vector, and V vector are provided as input, and computation parameters corresponding to the sizes of the input Q vector, K vector, and V vector are provided. The function of the computation accelerator node 1a is configured with node configuration data. The control unit included in the computation accelerator node 1a configures the configuration of the computation accelerator node 1a using the input node configuration data, stores the input Q vector, K vector, and V vector in the wideband memory, fetches the stored data, stores it in the internal memory 120, and performs matrix multiplication operation.

As described above, the dot product value d is obtained by performing matrix multiplication operation of the Q vector and the transposed K vector. The above process is as described in Equation 1 above. When the dot product operation of the input Q vector and K vector is completed, the computation accelerator node 1a outputs the dot product operation result d, the K vector, and node configuration data of the computation accelerator nodes 1b, 1c, and 1d to the subsequent computation accelerator node 1b.

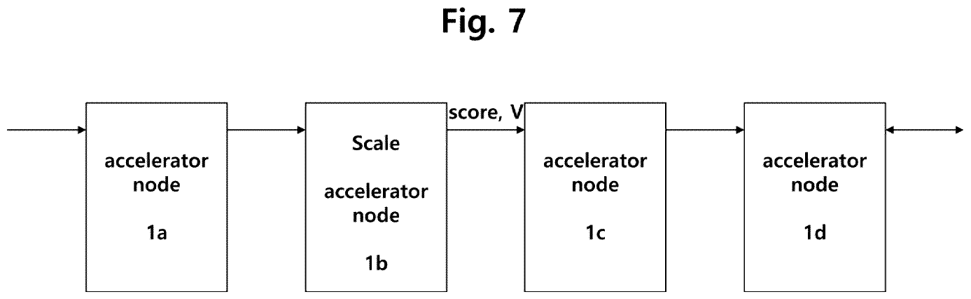

FIG. 7 is a diagram illustrating a subsequent state. Referring to FIG. 7, the computation accelerator node 1a provides the matrix multiplication result d, operator parameters for the scale operator to be performed by the computation accelerator node 1b, and computation parameters corresponding to the sizes of the d vector and V vector. The control unit included in the computation accelerator node 1b configures the configuration of the computation accelerator node 1b using the input node configuration data, stores the input vector in the wideband memory, fetches it to the internal memory 120, and scales the M vector, which is the matrix multiplication operation result, by the dimension of the K vector. The equation used for scaling is as in Equation 2 above. When the input scale operation is completed, the computation accelerator node 1b outputs the attention score, which is the result of the scale operation, the V vector, and node configuration data of the computation accelerator nodes 1c and 1d to the subsequent computation accelerator node 1c.

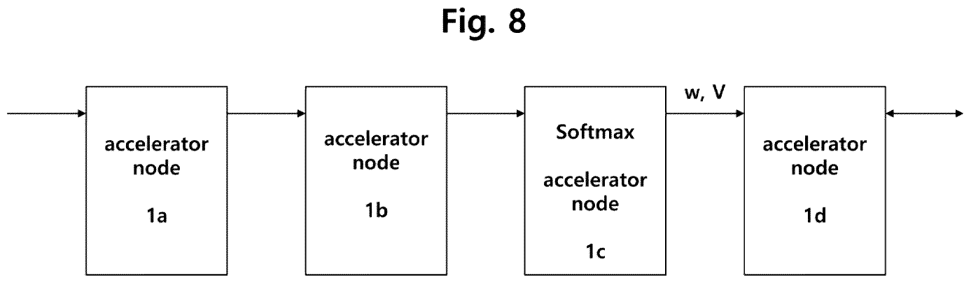

FIG. 8 is a diagram illustrating a subsequent state. Referring to FIG. 8, the computation accelerator node 1b provides the attention score, V vector, operator parameters for the softmax function operator to be performed by the computation accelerator node 1c, and computation parameters corresponding to the computation target. The control unit included in the computation accelerator node 1c configures the configuration of the computation accelerator node 1c using the input node configuration data, stores the input vector in the wideband memory, fetches it to the internal memory 120, and computes the softmax function operation result for the matrix multiplication operation result. The computation is as in the equation above. When the input scale operation is completed, the computation accelerator node 1c outputs the attention weight w, which is the result of the scale operation, the V vector, and node configuration data of the computation accelerator node 1d to the subsequent computation accelerator node 1d.

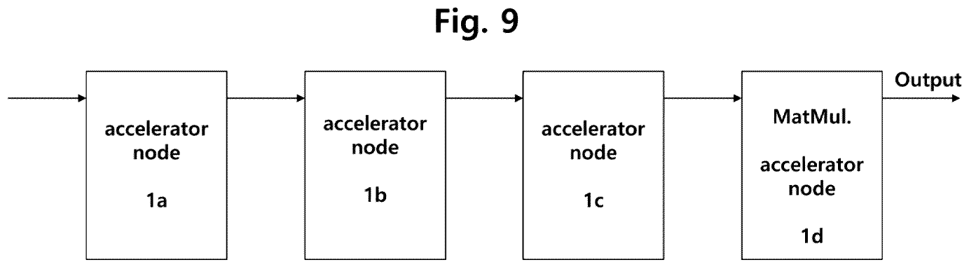

FIG. 9 is a diagram illustrating a subsequent state. Referring to FIG. 9, the computation accelerator node 1c provides the attention weight w and V vector. The control unit included in the computation accelerator node Id configures the configuration of the computation accelerator node 1d using the input node configuration data, stores the input values and vectors in the wideband memory, fetches them to the internal memory 120, and performs matrix multiplication operation on the attention weight w and V vector. The computation is as in the equation above. When the matrix multiplication operation is completed, the computation accelerator node 1d outputs the computation result to a subsequent computation accelerator node (not shown) through the transceiver or outputs to an external device through the PCI interface.

In the example illustrated in FIGS. 6 to 9, the connection is not released or new computation is not performed until the computation of all connected computation accelerator nodes 1a, 1b, 1c, and 1d is completed. However, in examples not shown, the connected computation accelerator nodes operate in a pipeline manner to improve computation time and computation efficiency.

At least one of the components, elements, modules or units (collectively “components” in this paragraph) represented by a block or an equivalent indication in the drawings including FIG. 3 may be implemented or embodied by analog and/or digital circuits including one or more of a logic gate, an integrated circuit, a microprocessor, a microcontroller, a memory circuit, a passive electronic component, an active electronic component, an optical component, and the like. Alternatively or additionally, these components may be implemented or embodied by software including one or more instructions stored in an internal or external storage medium including the memory 120 (FIG. 3) that is readable by at least one processor. For example, the at least one processor may invoke at least one of the one or more instructions stored in the storage medium, and execute it, with or without using one or more other components under the control of the at least one processor. This allows the at least one processor to perform at least one function or operation described above as being performed by each of the components according to the at least one instruction invoked. Here, the at least one processor may include a central processing unit (CPU), a graphic processing unit (GPU), another type of microprocessor, not being limited thereto.

To help understand the present invention, the embodiments shown in the drawings have been described as examples for implementation and are merely illustrative, and those skilled in the art will understand that various modifications and equivalent other embodiments are possible therefrom. Therefore, the true technical scope of protection of the present invention should be determined by the appended claims.

What is claimed is:

1. A transformer computation block with a plurality of acceleration nodes connected thereto, wherein each of the acceleration nodes comprises:
a first transceiver through which data is input and output;
a second transceiver through which data is input and output;
a Peripheral Component Interconnect (PCI) interface;
an interconnect switch for routing data within the computation accelerator;
a high bandwidth memory; and
a computation core comprising a computation unit performing MAC operations, an internal memory, and a control unit for performing computations,
wherein the computation block is configured to function as one of an encoder block and a decoder block of a transformer according to provided data.

2. The transformer computation block of claim 1, wherein the computation accelerator node is configured to perform one of operator functions comprising linearization, concatenation, layer normalization, matrix multiplication, scale, and softmax of a transformer according to input data.

3. The transformer computation block of claim 2, wherein in the transformer computation block, a preceding acceleration node provides feature data to a subsequent acceleration node configured to perform the configured operator function.

4. The transformer computation block of claim 1, wherein the acceleration node receives training data through one or more of the first transceiver, the second transceiver, and the PCI interface,
wherein the training data comprises:
one or more of: a number of self-attention heads;
a number of model layers being the number of layers of each of the encoder and decoder;
a model dimension being an output dimension of the layer; and
an internal dimension of a multi-layer perceptron.

5. The transformer computation block of claim 1, wherein the first transceiver and the second transceiver are gigabit transceivers, and
the transformer computation block has each of the plurality of acceleration nodes connected by the gigabit transceivers.

6. The transformer computation block of claim 1, wherein in the transformer computation block, a preceding acceleration node transmits function parameters to a subsequent acceleration node to configure the function of the transformer computation block.

7. The transformer computation block of claim 1, wherein in the transformer computation block, a preceding acceleration node transmits operator parameters to a subsequent acceleration node to configure an operator to be performed by the subsequent acceleration node.

8. The transformer computation block of claim 7, wherein the operator is one of linearization, concatenation, layer normalization, matrix multiplication, scale, softmax, addition, and activation function operators.

9. The transformer computation block of claim 7, wherein the preceding acceleration node transmits flow control parameters to a subsequent acceleration node to control the computation flow of the layer normalization operator.

10. The transformer computation block of claim 1, wherein in the transformer computation block, a preceding acceleration node transmits size configuration parameters for configuring the size of matrices or vectors used in internal blocks of a subsequent acceleration node.

11. The transformer computation block of claim 1, wherein in the transformer computation block, a most preceding acceleration node is configured by being provided with the data through the PCI interface.

12. The transformer computation block of claim 1, wherein in the transformer computation block, a last subsequent acceleration node outputs computation data through the PCI interface.

13. The transformer computation block of claim 1, wherein in the transformer computation block, the two or more acceleration nodes operate in a pipeline manner.

14. A computation accelerator node comprising:
a first transceiver and a second transceiver through which data is input and output;
a PCI interface;
a PCI controller for controlling the PCI interface;
an interconnect switch for routing data within the computation accelerator;
a high bandwidth memory; and
a computation core comprising a MAC array performing MAC operations, an internal memory, and a control unit for performing computations,
wherein the computation accelerator node performs an operator function of a transformer according to input data.

15. The computation accelerator node of claim 14, wherein the operator is one of linearization, concatenation, layer normalization, matrix multiplication, scale, and softmax operators.

16. The computation accelerator node of claim 14, wherein the first transceiver and the second transceiver are gigabit transceivers that input and output serial stream data.

17. A method for driving a plurality of computation accelerator nodes as a transformer computation block, the method comprising steps of:
configuring the computation accelerator node to correspond to training data upon the computation accelerator node receiving the training data;
configuring the computation accelerator node to correspond to node configuration data upon receiving node configuration data from a preceding computation accelerator node;
receiving feature data from the preceding computation accelerator node; and
outputting a computation result by performing computation with the provided feature data by the computation accelerator node configured with the training data and the node configuration data.

18. The method of claim 17, wherein the plurality of computation accelerator nodes are driven in a pipeline manner.

19. The method of claim 17, wherein the configuring of the computation accelerator node to correspond to the node configuration data is performed by configuring the computation accelerator node according to the node configuration data for performing one of operator functions comprising linearization, concatenation, layer normalization, matrix multiplication, scale, and softmax.

20. The method of claim 17, wherein the configuring of the computation accelerator node to correspond to the node configuration data is performed by configuring the computation accelerator node to function as one of a transformer encoder block and a decoder block.
